(19) United States
(12) Patent Application Publication
(10) Pub. No.: US 2026/0172529 A1
(43) Pub. Date: Jun. 18, 2026

(54) REAL-TIME USER NOTIFICATIONS IN VIRTUAL MEETINGS

(71) Applicant: Motorola Mobility LLC, Chicago, IL (US)

(72) Inventors: Amit Kumar Agrawal, Bangalore (IN); Krishnan Raghavan, Bangalore (IN); Nakul Patel, Bangalore (IN)

(73) Assignee: Motorola Mobility LLC, Chicago, IL (US)

(21) Appl. No.: 18/981,775

(22) Filed: Dec. 16, 2024

(51) Int. Cl. H04N 7/15; G10L 15/26

(52) U.S. Cl. CPC H04N 7/157; G10L 15/26

(57) ABSTRACT

In aspects of providing real-time user notifications in virtual meetings, a mobile device includes at least one memory and at least one processor coupled with the memory. The processor causes the mobile device to monitor the activity of a user during a virtual meeting in a communication application. In response to determining that the user is distracted, the processor causes the mobile device to monitor the context of the virtual meeting. The processor further causes the mobile device to provide a notification to the user in response to determining from the context that a request has been or is about to be directed to the user.

### BACKGROUND

Devices, such as smart devices, mobile devices (e.g., cellular phones, tablet devices, smartphones), and consumer electronics, can be implemented for use in a wide range of environments and for various applications. These devices often include communication applications that enable users to participate in virtual meetings, video conferences, and other remote collaboration sessions. Virtual meetings have become increasingly prevalent, allowing participants to connect and interact from various locations. However, the convenience of virtual meetings can sometimes lead to challenges in maintaining user engagement and attention throughout the meeting. During virtual meetings, participants may become distracted by other tasks, applications, or devices, potentially missing important information or requests directed to them. This can result in awkward pauses, repeated questions, or misunderstandings that disrupt the meeting flow.

### BRIEF DESCRIPTION OF THE DRAWINGS

Implementations of the techniques for real-time user notifications in virtual meetings are described with reference to the following Figures. The same numbers may be used throughout to reference like features and components shown in the Figures

FIG. 1 illustrates an example system for providing real-time user notifications in virtual meetings in accordance with one or more implementations as described herein.

FIG. 2 illustrates an example system in which aspects of providing real-time user notifications in virtual meetings can be implemented in accordance with one or more implementations as described herein.

FIG. 3 illustrates a flow diagram of an example procedure for providing real-time user notifications in virtual meetings in accordance with one or more implementations as described herein.

FIG. 4 illustrates an example method for providing real-time user notifications in virtual meetings in accordance with one or more implementations as described herein.

FIG. 5 illustrates various components of an example device that may be used to implement the techniques for real-time user notifications in virtual meetings as described herein.

### DETAILED DESCRIPTION

Implementations of the techniques for real-time user notifications in virtual meetings may be implemented as described herein. A mobile device, such as any type of wireless device, media device, mobile phone, flip phone, client device, tablet, computing, communication, entertainment, gaming, media playback, and/or any other type of computing and/or electronic device, or a system of any combination of such devices, may be configured to perform techniques for real-time user notifications in virtual meetings as described herein. For example, the mobile device implements a communication application that enables users to join and interact in virtual meetings, video conferences, or other remote collaboration sessions. In one or more implementations, a mobile device includes a meeting assistant, which can implement aspects of the techniques described herein.

Virtual meetings have become integral to modern communication and collaboration, transforming how individuals and organizations interact across distances. The increasing prevalence of virtual meetings can be attributed to technological advancements, business globalization, and the need for flexible work arrangements. These digital gatherings offer numerous benefits, including reduced travel costs, increased accessibility, and improved work-life balance for participants. As remote work and distributed teams become more common, virtual meetings provide a platform for real-time communication, fostering collaboration and maintaining team cohesion regardless of geographical boundaries. Global events such as pandemics have further emphasized the importance of virtual meetings, which have accelerated the adoption of remote work practices.

Conventional techniques for participating in virtual meetings may not adequately address the challenge of maintaining user engagement and attention throughout the meeting. For example, users may become distracted by other tasks, applications, or devices, potentially missing important information or requests directed to them. User distraction can result in awkward pauses, repeated questions, or misunderstandings that disrupt the meeting flow. Additionally, the ability to multitask during virtual meetings may lead to decreased overall meeting productivity and effectiveness. Furthermore, existing solutions do not provide context-aware notifications to re-engage distracted users at appropriate times, leading to inefficient meeting time and reduced participation from some users or over-participation from other attendees.

As described herein, a mobile device implements techniques for providing real-time user notifications in virtual meetings to address user distraction and engagement challenges. The mobile device monitors a user's activity during a virtual meeting in a communication application to determine if the user becomes distracted. When distraction is detected, the device begins monitoring the context of the virtual meeting, including transcribing and analyzing the meeting content in real time. If the system determines from the context that a request has been or is about to be directed to the user, timely notification is provided via a user interface to re-engage the user. This notification can include relevant context about the request and recent discussion points, allowing the user to catch up quickly and respond appropriately.

The techniques described herein offer several advantages over conventional approaches for virtual meetings. By providing context-aware, real-time notifications, the system helps prevent awkward pauses, repeated questions, and misunderstandings that disrupt meetings when users become distracted. The notifications result in more efficient meetings and improved participation. Additionally, the mobile device's ability to monitor user activity and meeting context allows for intelligent, targeted notifications rather than constant interruptions or reliance on the user to maintain focus, improving efficiency, especially for busy users. This balanced approach enables users to multitask when appropriate while ensuring they do not miss critical moments requesting their input, ultimately enhancing overall meeting effectiveness compared to conventional techniques that lack adaptive, context-aware notifications.

Consider an example scenario where Raj often struggles with long virtual meetings, particularly when his contributions are limited. During one two-hour call, he attempted to multitask but was caught off guard when asked a question, leading to embarrassment. In another meeting, he stayed fully focused but felt frustrated by the time wasted waiting for his brief input. These experiences highlight the challenges of conventional approaches to virtual meetings.

However, a user may have a more balanced and efficient experience with the real-time user notification system described herein. The system monitors an attendee's activity and the context of the meeting, providing timely alerts when user input is needed. The described techniques allow the user to engage in other tasks when appropriate, while also providing that the user does not miss critical moments user attention is requested or required. The context-aware notifications may include relevant information about a request and recent discussion points, enabling the user to catch up quickly and respond appropriately. In this way, the user can participate more effectively in virtual meetings, avoiding awkward situations and improving efficiency.

While features and concepts of the described techniques for real-time user notifications in virtual meetings are implemented in any number of different devices, systems, environments, and/or configurations, implementations of the techniques for real-time user notifications in virtual meetings are described in the context of the following example devices, systems, and methods.

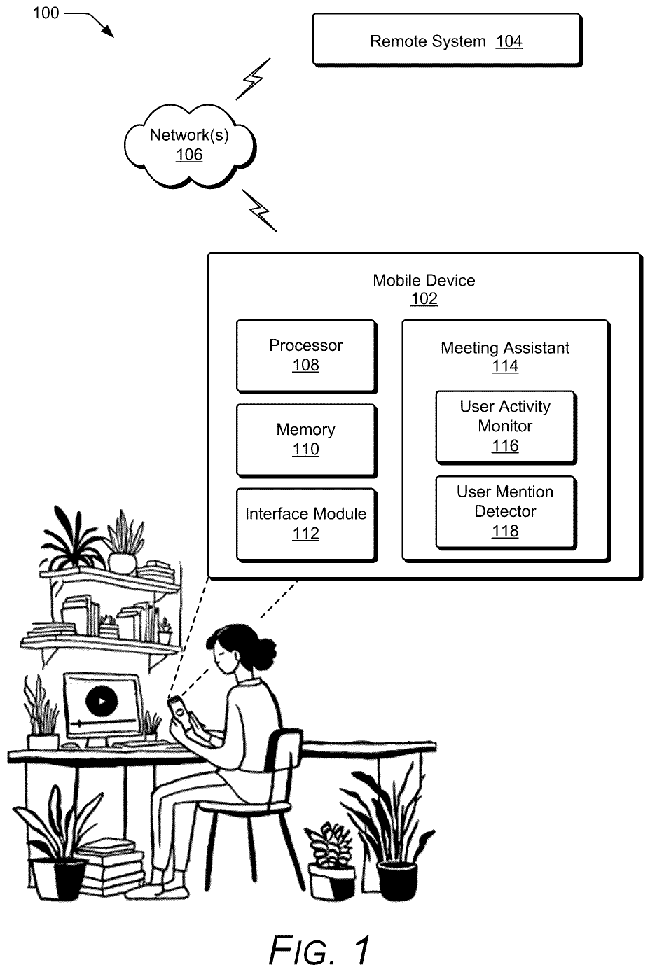

FIG. 1 illustrates an example system 100 for real-time user notifications in virtual meetings, as described herein. The example system 100 includes a mobile device 102 and a remote system 104, where the mobile device 102 and the remote system 104 may be interconnectable via one or more networks 106. The remote system 104 may be remote from or independent of mobile device 102 (e.g., in a physical location different from mobile device 102, which is not collocated). The mobile device 102 and/or the remote system 104 may range from a full-resource device with substantial memory and processor resources to a low-resource device with reduced memory and/or processing resources. Although in some instances, reference is made to a mobile device 102 and a remote system 104, respectively, in the singular, a mobile device 102 and a remote system 104 may also represent multiple different devices in some cases. The mobile device 102 and a remote system 104 may include one or more features in addition to, or as an alternative to, the features illustrated in the system 100.

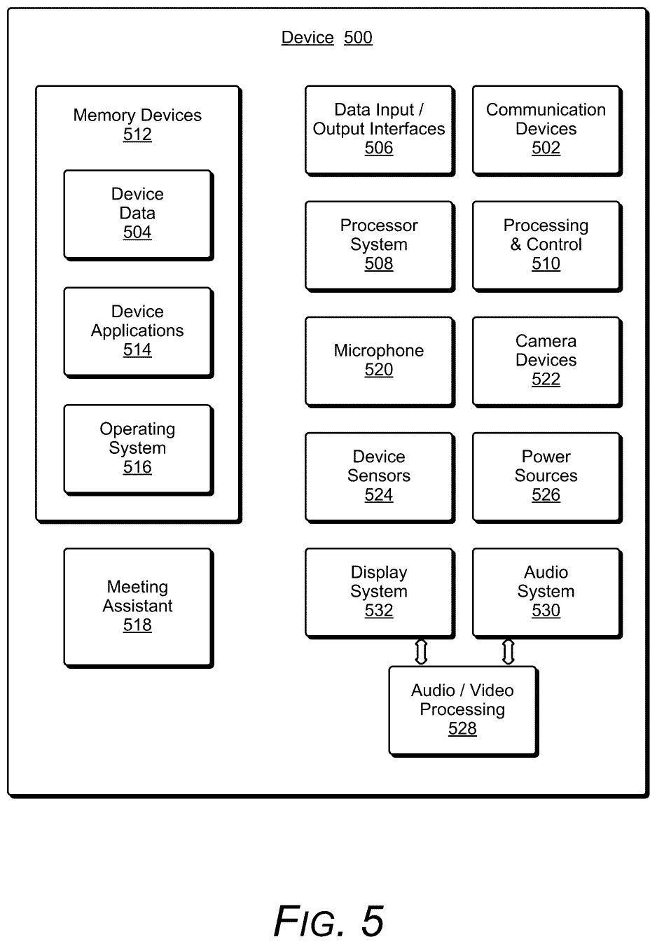

Examples of mobile device 102 include at least one of any type of a wireless device, mobile device, smartphone, mobile phone, flip phone, client device, companion device, laptop, tablet, computing device, communication device, entertainment device, gaming device, media playback device, and/or any other type of computing or electronic device. The mobile device 102 can be implemented with various components, such as a processor 108 and memory 110, as well as any number and combination of different components as further described with reference to the example device shown in FIG. 5.

In some examples, the remote system 104 may include a server device, cloud computing system, or other networked computing device. The remote system 104 can be implemented with various components, such as a processor system and memory, as well as any number and combination of different components. The remote system 104 may provide additional processing or data storage capabilities to support the meeting assistance functionality. For example, the remote system 104 may host machine learning models for speech recognition and natural language processing to analyze meeting transcripts in real time. Additionally, the remote system 104 may store user preferences and personal knowledge bases to enhance the context-aware notifications provided by the mobile device 102.

In one or more implementations, the mobile device 102 and the remote system 104 include various radios for wireless communication (e.g., via networks 106). For example, the mobile device 102 and the remote system 104 can include a Bluetooth (BT) and/or Bluetooth Low Energy (BLE) transceiver, as well as a near-field communication (NFC) transceiver. The mobile device 102 and the remote system 104 can also include a Wi-Fi radio, a cellular radio, and/or other device communication interfaces.

In some implementations, the devices, applications, modules, servers, and/or services described herein communicate via one or more communication networks 106, such as for data communication with the mobile device 102. The communication network 106 includes a wired and/or wireless network. The communication network 106 is implemented using any type of network topology and/or communication protocol and is represented or otherwise implemented as a combination of two or more networks, including IP-based networks, cellular networks, and/or the Internet. The communication network 106 includes mobile operator networks managed by a mobile network operator and/or other network operators, such as a communication service provider, mobile phone provider, and/or Internet service provider.

Mobile device 102 includes various functionalities enabling the device to provide real-time user notifications in virtual meetings, as described herein. In one or more examples, an interface module 112 represents functionality (e.g., logic and/or hardware) enabling the mobile device 102 to interconnect and interface with other devices and/or networks, such as the communication network 106. For example, the interface module 112 enables wireless and/or wired connectivity of the mobile device 102.

The mobile device 102 can include and implement various device applications, such as any type of messaging application, email application, video communication application, cellular communication application, music/audio application, gaming application, media application, social platform application, and/or any other of the many possible types of various device applications. Many device applications have an associated user interface that is generated and displayed for user interaction and viewing, such as on a display screen of the mobile device 102. Generally, an application user interface, or any other type of video, image, graphic, and the like, is digital image content that is displayable on the display screen of the mobile device 102.

In the example system 100 for real-time user notifications in virtual meetings, the mobile device 102 implements a meeting assistant 114 (e.g., as a device application or as a portion of a communication application). As shown in this example, the meeting assistant 114 represents functionality (e.g., logic, software, and/or hardware) enabling aspects of the described techniques for generating real-time user notifications in virtual meetings. The meeting assistant 114 can be implemented as computer instructions stored on computer-readable storage media (e.g., memory 110) and executed by a processor system (e.g., the processor 108) of the mobile device 102. Alternatively, or in addition, the meeting assistant 114 can be implemented at least partially in the device's hardware. The meeting assistant 114 includes a user activity monitor 116 and a user mention detector 118. These components may work together to monitor the user's engagement during virtual meetings and identify when the user is mentioned or addressed in the meeting.

The meeting assistant 114 facilitates the monitoring and analysis of user engagement during virtual meetings. The user activity monitor 116 tracks the user's activity and engagement levels during a virtual meeting, detecting potential distractions such as application usage, device usage, user activity, or ambient noise. The user activity monitor can utilize various sensors and data sources on the mobile device 102 to assess the user's focus and attention. For example, the mobile device 102 may incorporate various sensors, such as microphones, cameras, and device sensors. These sensors may allow mobile device 102 to collect data to monitor user activity during virtual meetings. In some cases, the mobile device 102 may collect sensor data to determine if a user is distracted during a virtual meeting. For example, the mobile device 102 may detect application usage, device usage, user activity, or ambient noise through its sensors to assess user distraction.

The user mention detector 118 analyzes the meeting context in real-time, identifying instances where the user is mentioned, addressed, or expected to contribute. This detection may involve processing audio transcripts, analyzing shared content, and interpreting meeting dynamics. Together, the user activity monitor 116 and user mention detector 118 enable the meeting assistant 114 to provide timely and context-aware notifications to re-engage users who may be distracted.

The meeting assistant 114 can coordinate with other device components, such as the processor 108 and memory 110, to implement machine learning models for speech recognition and natural language processing. These models can transcribe and analyze meeting content in real-time, extracting relevant context and identifying potential requests directed at the user. The interface module 112 may facilitate the delivery of notifications through various modalities, such as visual alerts, audio cues, or tactile feedback. Additionally, the meeting assistant 114 can interact with the remote system 104 via network 106 to access additional processing power, storage (e.g., user preferences or a personal knowledge base associated with the user), or specialized services that enhance its capabilities in providing real-time user notifications during virtual meetings.

The described system 100 for real-time user notifications in virtual meetings may offer several advantages for users, such as the one illustrated in FIG. 1 during a virtual meeting on her mobile device 102. The user is illustrated as watching multimedia on a nearby computer and may have varying levels of distraction throughout the virtual meeting. The meeting assistant 114 on the mobile device 102 enables continuous, real-time monitoring of user engagement without requesting manual input or constant attention from the user. This may allow for more natural and efficient multitasking during virtual meetings. For example, the user activity monitor 116 and user mention detector 118 can work in tandem to provide targeted and contextually relevant notifications, potentially reducing unnecessary interruptions and alerting users when their input may be needed.

The ability to process and analyze meeting context locally on the mobile device 102 may enhance privacy and reduce latency in notification delivery. In other implementations, the system's integration with the remote system 104 via networks 106 may allow for scalability and access to more powerful resources when needed without compromising the mobile device's performance. By leveraging the various components illustrated in FIG. 1, system 100 may offer an intuitive, efficient, and context-aware solution for maintaining user engagement in virtual meetings, potentially improving meeting productivity and user experience across diverse devices and environments.

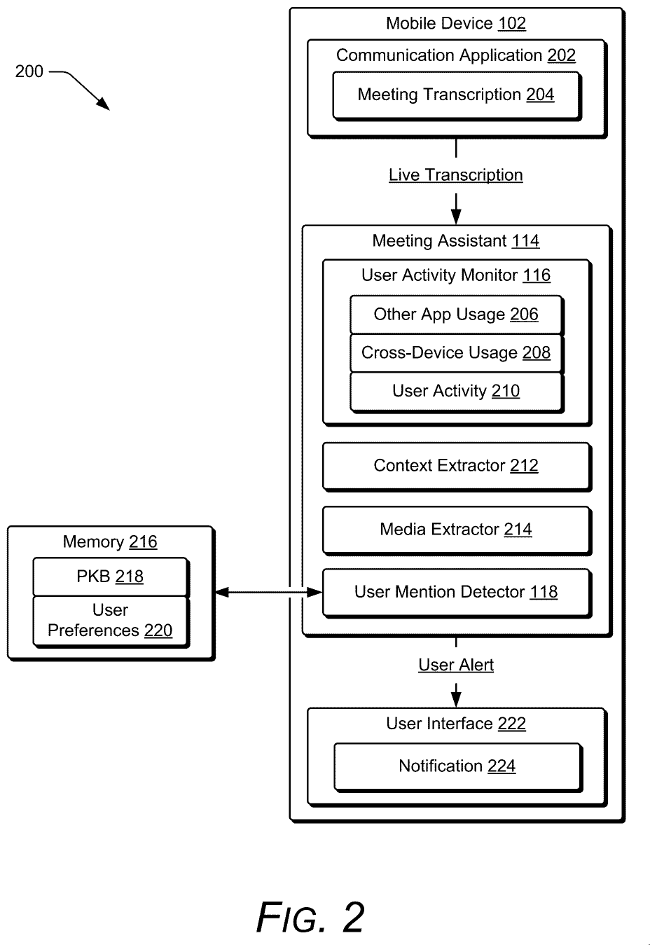

FIG. 2 illustrates an example system 200 for providing real-time user notifications in virtual meetings in accordance with one or more implementations as described herein. The example system 200 may implement aspects of the example system 100. For example, the example system 200 can be implemented by a mobile device 102 with a communication application 202, a meeting assistant 114, and a user interface 222 to facilitate monitoring of user activity and providing notifications during virtual meetings, where the mobile device 102, the meeting assistant 114, and the user interface 222 may be examples of the corresponding components as described with reference to FIG. 1.

In some examples, the mobile device 102 provides communication capabilities, such as virtual telephonic or video conferences, using the communication application 202. The communication application 202 refers to software that enables users to participate in virtual meetings, video conferences, and other remote collaboration sessions. For example, the communication application 202 facilitates audio and video calls, screen sharing, and text-based chat during virtual meetings. The meeting transcription 204 includes a real-time conversion of spoken words in a virtual meeting into written text. For instance, the meeting transcription 204 can capture and transcribe a presenter's speech during a product demonstration.

The meeting assistant 114 uses the user activity monitor 116 to analyze activity data associated with the user to determine if the user is distracted. User activity may encompass various actions and behaviors of a user during a virtual meeting, such as speaking, listening, or multitasking. For example, the user activity monitor 116 monitors for other app usage 206, cross-device usage 208, and user activity 210 to determine whether the user is distracted during the virtual meeting. Other app usage 206 refers to a user's interaction with applications on the mobile device 102 outside of the communication application 202. Examples may include checking emails, browsing social media, or working on documents during a virtual meeting. Cross-device usage 208 involves a user's engagement with multiple devices simultaneously using a connected device monitoring solution to determine is actively engaged on or using another electronic device. For example, a user may participate in a virtual meeting on their laptop while checking messages on their smartphone. User activity 210 refers to a user's physical characteristics that may indicate their distraction. As described above, sensors (e.g., camera, microphone, radar) can be used to determine if the user has walked away from the mobile device 102, is facing away from the screen, or is engaged in a conversation with other persons outside of the virtual meeting.

When distraction is detected, the meeting assistant 114 uses the context extractor 212 to begin monitoring the context of the virtual meeting using the meeting transcription 204 (e.g., a live transcription of the virtual meeting). Context extractor 212 and media extractor 214 work together to analyze the meeting content and any shared media in real-time. The user mention detector 118, using a personal knowledge base 218 and user preferences 220, identifies when the user is mentioned, will likely be mentioned soon, or is expected to contribute to the meeting. Based on this analysis, the meeting assistant 114 generates an alert, which is then presented to via the user interface 222 as a notification 224. This process implements the monitoring, analysis, and notification aspects described in FIG. 1, providing a more detailed view of how these components interact within the mobile device 102 to deliver real-time, context-aware notifications during virtual meetings.

The meeting assistant 114 at the mobile device 102 coordinates the monitoring, analysis, and notification processes during virtual meetings. In addition, the meeting assistant 114 can interact with various components to provide real-time, context-aware assistance to users. The user activity monitor 116 tracks the user's engagement levels during a virtual meeting, detecting potential distractions such as other app usage 206, cross-device usage 208, and user activity 210. For example, the user activity monitor 116 may recognize when a user switches to a different application during the meeting. In response to this recognition, the context extractor 212 analyzes the meeting transcription 204 and other meeting content to understand the current topic and discussion flow. For example, the context extractor 212 can identify key points, action items, and relevant context that may be important for user engagement and understanding future requests (e.g., questions, invitations, and inquiries. The media extractor 214 processes visual content shared during the meeting, such as slides or documents, to extract relevant information to support and assist the context extractor 212.

The user mention detector 118 analyzes the meeting context in real-time to identify instances where the user is mentioned, addressed, expected to contribute, or will likely be placed in one of those situations soon. The user mention detector 118 can utilize a machine-learning model trained on various inputs, including the live transcription from the meeting transcription 204, the user's personal knowledge base 218, and user preferences 220 to assist with identifying and predicting requests directed at the user. This model may be designed to recognize patterns and cues in the meeting dialogue that suggest the user's input may be requested. For example, the machine-learning model detects when the user's name, nickname, job title, or role is mentioned, when a topic related to the user's expertise is discussed, or when a question is directed at the user's role or department. The machine-learning model can be trained on diverse datasets of meeting transcripts labeled with examples of user mentions and requests for input. During operation, the machine-learning model analyzes the live transcript in real time, considering factors such as speaker identity, discussion topic, and meeting context. The user mention detector 118 can also incorporate information from the personal knowledge base 218, such as the user's project assignments or areas of responsibility, to better identify relevant moments for the user. The user preferences 220 can influence the model's decision-making process, adjusting the threshold for generating alerts based on the user's desired level of engagement.

The personal knowledge base 218 refers to a collection of information specific to a user, including their name, nickname(s), title, role, areas of expertise, project involvement, and communication history. For instance, the personal knowledge base 218 may contain details about a user's role in a particular project discussed during a meeting. User preferences 220 include settings and choices made explicitly or implicitly by a user regarding how they wish to receive notifications and interact with the meeting assistant 114. For example, a user may prefer alerts for certain topics or keywords.

The user interface 222 serves as a means of interaction between the meeting assistant 114 and the user. For example, the user interface 222 can generate notifications 224 generated by the meeting assistant 114, providing visual, audio, or tactile alerts to re-engage the user when necessary. The user interface 222 can show a pop-up message summarizing the current discussion topic and indicating that the user's input may be requested soon. The user interface 222 can also allow users to customize their notification preferences and provide feedback on the relevance and timing of alerts, which can further refine the machine-learning model and improve the overall effectiveness of the meeting assistant 114.

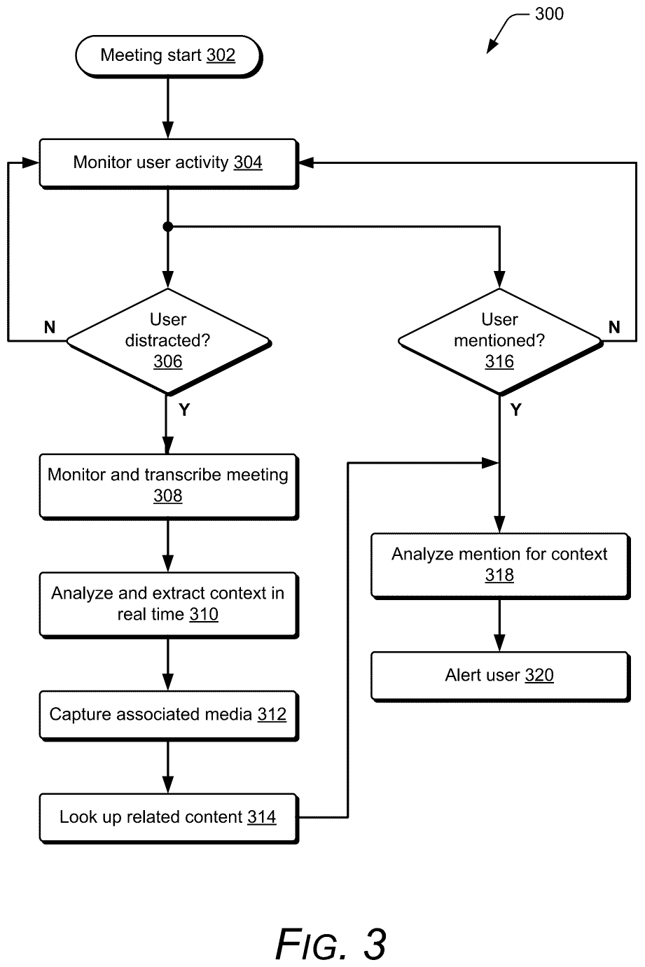

FIG. 3 illustrates a flow diagram of an example procedure 300 for providing real-time user notifications in virtual meetings. In some aspects, any services, components, modules, methods, and/or operations described herein for FIGS. 3 and/or 4 may be implemented using software, firmware, hardware (e.g., fixed logic circuitry), manual processing, or any combination thereof. Some operations of the example procedure 300 or method 400 may be described in the general context of executable instructions stored on computer-readable storage memory that is local and/or remote to a computer processing system, and implementations may include software applications, programs, functions, and the like. Alternatively, or in addition, any of the functionality described herein may be performed, at least in part, by one or more hardware logic components, such as, and without limitation, field-programmable gate arrays (FPGAs), application-specific integrated circuits (ASICs), application-specific standard products (ASSPs), system-on-a-chip systems (SoCs), complex programmable logic devices (CPLDs), and the like.

The order in which the procedure 300 or method 400 is described is not intended to be construed as a limitation, and any number or combination of the described operations may be performed in any order to implement the procedure, or an alternate procedure.

At 302, a virtual meeting is started. By way of example, the communication application 202 on the mobile device 102 begins a virtual meeting session, connecting the user with other participants.

At 304, the system monitors user activity. For instance, the user activity monitor 116 tracks the user's engagement with the mobile device 102, including interactions with the communication application 202 and other applications. In some aspects, the user activity monitor 116 can also track cross-device usage 208 to determine if the user is engaging with other devices during the meeting or user activity 210 to assess the user's engagement with the virtual meeting.

At 306, the system determines whether the user is distracted. By way of example, the user activity monitor 116 analyzes data from other app usage 206, cross-device usage 208, and user activity 210 to determine if the user's attention has shifted away from the virtual meeting. In some implementations, the system may use focus tracking services or ambient noise detection to assess user distraction. If the user is determined to not be distracted (e.g., a “no” or “N” determination at block 306), the system returns to block 304.

At 308, if the user is determined to be distracted (e.g., a “yes” or “Y” determination at block 306), the system monitors and transcribes the meeting. For instance, the communication application 202 provides the meeting transcription 204 to the context extractor 212. In some implementations, this transcription or real-time analysis thereof is initiated only when distraction is detected to conserve system resources.

At 310, the system analyzes and extracts context in real-time. By way of example, the context extractor 212 processes the meeting transcription 204 to understand the current topic, discussion flow, and potential areas of relevance to the user. The context analysis can use natural language processing techniques to identify key points and action items from the meeting transcription 204.

At 312, the system captures associated media. For instance, the media extractor 214 processes any visual content shared during the meeting, such as slides or documents, to extract relevant information and provides this information to the context extractor 212. In one implementation, the media extractor 214 can take snapshots of shared screens or parse text from presentation materials to supplement the meeting transcription 204 analyzed by the context extractor 212.

At 314, the system looks up related content. By way of example, the meeting assistant 114 or user mention detector 118 queries the personal knowledge base 218 or user preferences 220 to find information relevant to the current meeting context, such as the user's previous interactions or expertise related to the topic. This may also involve searching the user's emails or other personal documents for pertinent information in some implementations.

At 316, the system determines whether the user is mentioned or is likely to be mentioned soon. For instance, the user mention detector 118 analyzes the meeting transcription 204 and context to identify if the user's name, role, or area of expertise is referenced. In some implementations, the user mention detector 118 detects variations of the user's name or identifies when topics related to the user's responsibilities are discussed. If the user is not mentioned or is not likely to be mentioned soon (e.g., a “no” or “N” determination at block 316), the system returns to block 304.

At 318, if the user is mentioned (e.g., a “yes” or “Y” determination at block 316), the system analyzes the mention for context. By way of example, the user mention detector 118 can examine the surrounding discussion to understand the nature and urgency of the mention. This analysis may involve assessing the speaker's identity, the specific question asked, or the topic being discussed.

At 320, the system alerts the user. For instance, the meeting assistant 114 generates a notification 224 via the user interface 222, potentially including relevant context about the mention and recent discussion points. In some aspects, this notification 224 is customizable based on user preferences 220, such as preferred alert types or notification frequency.

After alerting the user or if the user is not mentioned (e.g., a “no” or “N” determination at block 316), the procedure 300 loops back to block 304 to continue monitoring user activity. This may create a continuous cycle of monitoring, analysis, and notification throughout the duration of the virtual meeting. In some implementations, the system may adjust its monitoring intensity or notification frequency based on the user's engagement patterns over time.

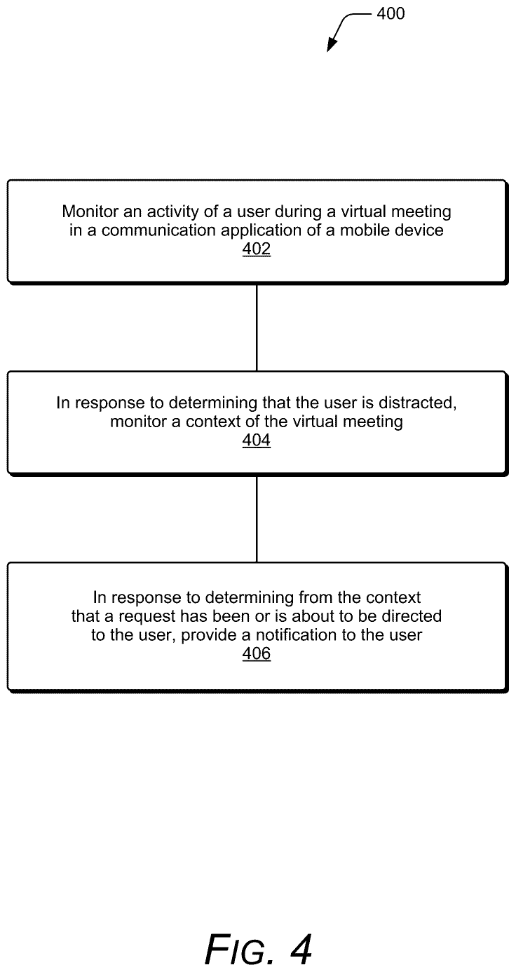

FIG. 4 illustrates an example method 400 for providing real-time user notifications in virtual meetings in accordance with one or more implementations of the techniques described herein.

At 402, an activity of a user during a virtual meeting in a communication application of a mobile device is monitored. By way of example, the user activity monitor 116 tracks the user's engagement with the mobile device 102, including interactions with the communication application 202 and other applications. The user activity monitor 116 determines that the user is distracted based on one or more of application usage, device usage, or ambient noise. In another implementation, the user activity monitor 116 can determine that the user is distracted by determining, using a focus tracking service of the mobile device 102, that the user is not focused on the virtual meeting. The focus tracking service, for example, can monitor where the user's eyes are primarily focused over a span of time, whether the user is engaged in separate communications from the virtual meeting, and/or whether the user is facing the screen or device on which the virtual meeting is being held.

At 404, in response to determining that the user is distracted, a context of the virtual meeting is monitored. By way of example, the meeting assistant 114 begins monitoring the context of the virtual meeting using the context extractor 212. The context extractor 212 and media extractor 214 may work together to analyze the meeting content and any shared media in real time. The mobile device 102 can determine the context of the virtual meeting by transcribing, using a machine-learning model with real-time automated speech recognition, the virtual meeting and determining, using the machine-learning model or another machine-learning model with natural language processing, an updated context of the virtual meeting in real-time. Context extractor 212 can also monitor the context of the virtual meeting by analyzing shared content identified by the media extractor 214. In some implementations, the mobile device 102 can cease transcribing the virtual meeting and/or determining the context in response to determining that the user is no longer distracted.

At 406, in response to determining from the context that a request has been or is about to be directed to the user, a notification is provided to the user via a user interface of the mobile device. By way of example, the meeting assistant 114 generates a notification 224 and displays it through the user interface 222. The user mention detector 118 can determine that the user is requested or is about to be requested to provide information by identifying the name, nickname, or role of the user raised in the virtual meeting. Additionally, the user mention detector 118 can further determine that the user is requested or is about to be requested to provide information by identifying that a topic, a subject, or information associated with the user or typically requesting the user's input is raised in the virtual meeting.

The notification 224 includes one or more of a visual alert, an audio alert, a text message, or a tactile alert. The notification 224 can also include an identification of a speaker that generated the request and an identification or summary of the (predicted) request. In some implementations, the notification 224 may also include a summary of recent discussion points in the virtual meeting. The meeting assistant 114 can customize the notification 224 based on user preferences 220 stored in the memory. In one implementation, the meeting assistant 114 prioritizes notifications based on a relevance score calculated for each potential request.

In some implementations, the meeting assistant 114 provides a quick response option (e.g., via a text message to deliver) with the notification, allowing the user to respond to the request without fully re-engaging in the virtual meeting. The mobile device implementing this method may include a smartphone, a mobile phone, a flip phone, a client device, a laptop, a tablet, a computing device, an entertainment device, or a gaming device.

FIG. 5 illustrates various components of an example device 500, which can implement aspects of the techniques and features for real-time user notifications in virtual meetings, as described herein. The example device 500 may be implemented as any of the devices described with reference to the previous FIGS. 1-4, such as any type of wireless device, mobile device, mobile phone, flip phone, client device, companion device, display device, tablet, computing, communication, entertainment, gaming, media playback, and/or any other type of computing and/or electronic device. For example, the mobile device 102 described with reference to FIGS. 1-4 may be implemented as the example device 500.

The example device 500 can include various, different communication devices 502 that enable wired and/or wireless communication of device data 504 with other devices. The device data 504 can include any of the various device data and content that is generated, processed, determined, received, stored, and/or communicated from one computing device to another. Generally, the device data 504 can include any form of audio, video, image, graphics, and/or electronic data generated by applications executing on a device. The communication devices 502 can also include transceivers for cellular phone communication and/or for any type of network data communication.

The example device 500 can also include various and different types of data input/output (I/O) interfaces 506, such as data network interfaces that provide connection and/or communication links between the devices, data networks, and other devices. The data I/O interfaces 506 may be used to couple the device to any type of components, peripherals, and/or accessory devices, such as a computer input device that may be integrated with the example device 500. The I/O interfaces 506 may also include data input ports via which any type of data, information, media content, communications, messages, and/or inputs may be received, such as user inputs to the device, as well as any type of audio, video, image, graphics, and/or electronic data received from any content and/or data source.

The example device 500 includes a processor system 508 of one or more processors (e.g., any of microprocessors, controllers, and the like) and/or a processor and memory system implemented as a system-on-chip (SoC) that processes computer-executable instructions. The processor system 508 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits 510. The example device 500 may also include any type of a system bus or other data and command transfer system that couples the various components within the device. A system bus can include any one or combination of different bus structures and architectures, as well as control and data lines.

The example device 500 also includes memory and/or memory devices 512 (e.g., computer-readable storage memory) that enable data storage, such as data storage devices implemented in hardware that may be accessed by a computing device and that provide persistent storage of data and executable instructions (e.g., software applications, programs, functions, and the like). Examples of memory devices 512 include volatile memory and non-volatile memory, fixed and removable media devices, and any suitable memory device or electronic data storage that maintains data for computing device access. The memory devices 512 can include various implementations of random-access memory (RAM), read-only memory (ROM), flash memory, and other types of storage media in various memory device configurations. The example device 500 may also include a mass storage media device.

Memory devices 512 (e.g., computer-readable storage memory) provide data storage mechanisms, such as storing device data 504, other types of information and/or electronic data, and various device applications 514 (e.g., software applications and/or modules). For example, an operating system 516 may be maintained as software instructions with a memory device 512 and executed by the processor system 508 as a software application. The device applications 514 may also include a device manager, such as any form of a control application, software application, signal-processing and control module, code specific to a particular device, a hardware abstraction layer for a particular device, and so on.

In this example, the device 500 includes a meeting assistant 518 that implements various aspects of the features and techniques described herein. The meeting assistant 518 may be implemented with hardware components and/or in software as one of the device applications 514, such as when the example device 500 is implemented as the mobile device 102 described with reference to FIGS. 1-4. An example of the meeting assistant 518 is the meeting assistant 114 implemented by the mobile device 102, such as a software application and/or as hardware components in the mobile device. In implementations, the meeting assistant 518 may include independent processing, memory, and logic components as a computing and/or electronic device integrated with the example device 500.

The example device 500 can also include a microphone 520 (e.g., to capture audio and/or an audio recording) and/or camera devices 522 (e.g., to capture digital images and/or video images), as well as device sensors 524, such as may be implemented as components of an inertial measurement unit (IMU). The device sensors 524 may be implemented with various sensors, such as a gyroscope, an accelerometer, and/or other types of motion sensors to sense the motion of the device. The device sensors 524 can generate sensor data vectors having three-dimensional parameters (e.g., rotational vectors in x, y, and z-axis coordinates) indicating the location, position, acceleration, rotational speed, and/or orientation of the device. The example device 500 can also include one or more power sources 526, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 500 can also include an audio and/or video processing system 528 that generates audio data for an audio system 530 and/or generates display data for a display system 532. The audio system 530 and/or the display system 532 may include any types of devices or modules that generate, process, display, and/or otherwise render audio, video, display, and/or image data. Display data and audio signals may be communicated to an audio component and/or to a display component via any type of audio and/or video connection or data link. In implementations, the audio system 530 and/or the display system 532 are integrated components of the example device 500. Alternatively, the audio system 530 and/or the display system 532 are external, peripheral components to the example device.

Although implementations for real-time user notifications in virtual meetings have been described in language specific to features and/or methods, the appended claims are not necessarily limited to the specific features or methods described. Rather, the specific features and methods are disclosed as example implementations for real-time user notifications in virtual meetings, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device comprising at least one memory and at least one processor coupled with the at least one memory and configured to cause the mobile device to monitor an activity of a user during a virtual meeting in a communication application, in response to determining that the user is distracted, monitor a context of the virtual meeting, and, in response to determining from the context that a request has been or is about to be directed to the user, provide, via a user interface of the mobile device, a notification to the user.

A mobile device wherein the at least one processor is configured to cause the mobile device to determine that the user is distracted based on one or more of application usage, device usage, user activity, or ambient noise.

A mobile device wherein the at least one processor is configured to cause the mobile device to determine the context of the virtual meeting by transcribing, using a machine-learning model with real-time automated speech recognition, the virtual meeting and determining, using the machine-learning model with natural language processing, an updated context of the virtual meeting in real-time.

A mobile device wherein the at least one processor is configured to cause the mobile device to monitor the context of the virtual meeting by analyzing shared multimedia content in the virtual meeting.

A mobile device wherein the at least one processor is configured to cause the mobile device to cease transcribing the virtual meeting and cease determining the updated context in response to determining that the user is no longer distracted.

A mobile device wherein the at least one processor is configured to cause the mobile device to determine that the user is requested or is about to be requested to provide information by identifying a name or role of the user is raised in the virtual meeting.

A mobile device wherein the at least one processor is configured to cause the mobile device to further determine that the user is requested or is about to be requested to provide information by identifying that a topic, a subject, or information associated with the user is raised in the virtual meeting.

A mobile device wherein the notification includes one or more of a visual alert, an audio alert, a text message, or a tactile alert.

A mobile device wherein the notification includes an identification of a speaker that generated the request and an identification or summary of the request.

A mobile device wherein the at least one processor is configured to cause the mobile device to customize the notification based on user preferences stored in the memory.

A mobile device wherein the at least one processor is configured to cause the mobile device to prioritize notifications based on a relevance score calculated for each potential notification.

A mobile device wherein the mobile device comprises a smartphone, a mobile phone, a flip phone, a client device, a laptop, a tablet, a computing device, an entertainment device, or a gaming device.

Alternatively, or in addition to the above-described mobile device, any one or combination of:

A method comprising: monitoring an activity of a user during a virtual meeting in a communication application, in response to determining that the user is distracted, monitoring a context of the virtual meeting, and in response to determining from the context that a request has been or is about to be directed to the user, providing, via a user interface of the mobile device, a notification to the user.

A method wherein determining the context of the virtual meeting comprises: transcribing, using a machine-learning model with real-time automated speech recognition, the virtual meeting, and determining, using the machine-learning model with natural language processing, an updated context of the virtual meeting in real-time.

A method wherein determining that the user is requested or is about to be requested to provide information comprises one or more of: identifying a name or role of the user is raised in the virtual meeting, or identifying a topic, a subject, or information associated with the user raised in the virtual meeting.

A method wherein the notification includes one or more of a visual alert, an audio alert, a text message, or a tactile alert.

A method wherein: monitoring the activity of the user during the virtual meeting is performed continuously, and monitoring the context of the virtual meeting is performed only in response to determining that the user is distracted.

Alternatively, or in addition to the above-described method, any one or combination of:

A system comprising: a memory, and a processor to: monitor an activity of a user during a virtual meeting in a communication application, in response to determining that the user is distracted, monitor a context of the virtual meeting, and in response to determining from the context that a request has been or is about to be directed to the user, provide, via a user interface of the mobile device, a notification to the user.

A system wherein the processor is configured to determine that the user is distracted based on one or more of application usage, device usage, user activity, or ambient noise.

A system wherein the processor is configured to determine the context of the virtual meeting by: transcribing, using a machine-learning model with real-time automated speech recognition, the virtual meeting, determining, using the machine-learning model with natural language processing, an updated context of the virtual meeting in real-time, and analyzing shared multimedia content in the virtual meeting.

1. A mobile device, comprising:
at least one memory; and
at least one processor coupled with the at least one memory and configured to cause the mobile device to:
monitor an activity of a user during a virtual meeting in a communication application;
in response to determining that the user is distracted, monitor a context of the virtual meeting; and
in response to determining from the context that a request has been or is about to be directed to the user, provide a notification to the user.

2. The mobile device of claim 1, wherein the at least one processor is configured to cause the mobile device to determine that the user is distracted based on one or more of application usage, device usage, user activity, or ambient noise.

3. The mobile device of claim 1, wherein, to determine the context of the virtual meeting, the at least one processor is configured to cause the mobile device to:
transcribe, using a machine-learning model with real-time automated speech recognition, the virtual meeting; and
determine, using the machine-learning model with natural language processing, an updated context of the virtual meeting in real-time.

4. The mobile device of claim 3, wherein, to monitor the context of the virtual meeting, the at least one processor is configured to cause the mobile device to analyze shared multimedia content in the virtual meeting.

5. The mobile device of claim 3, wherein the at least one processor is configured to cause the mobile device to cease transcribing the virtual meeting and cease determining the updated context in response to a determination that the user is no longer distracted.

6. The mobile device of claim 3, wherein, to determine that the user is requested or is about to be requested to provide information, the at least one processor is configured to cause the mobile device to identify a name or a role of the user in the context of the virtual meeting.

7. The mobile device of claim 6, wherein the at least one processor is configured to cause the mobile device to determine that the user is requested or is about to be requested to provide information based on a topic, a subject, or information associated with the user is identified in the context of the virtual meeting.

8. The mobile device of claim 1, wherein the notification includes one or more of a visual alert, an audio alert, a text message, or a tactile alert.

9. The mobile device of claim 8, wherein the notification includes one or more of an identification of a speaker that generated the request, an identification of the request, or a summary of the request.

10. The mobile device of claim 8, wherein the at least one processor is configured to cause the mobile device to customize a type of the notification based on user preferences.

11. The mobile device of claim 1, wherein the at least one processor is configured to cause the mobile device to prioritize notifications based on a relevance score calculated for each potential notification.

12. A method comprising:
monitoring an activity of a user during a virtual meeting in a communication application;
in response to determining that the user is distracted, monitoring a context of the virtual meeting; and
in response to determining from the context that a request has been or is about to be directed to the user, providing an alert notification.

13. The method of claim 12, wherein determining the context of the virtual meeting comprises:
transcribing, using a machine-learning model with real-time automated speech recognition, the virtual meeting; and
determining, using the machine-learning model with natural language processing, an updated context of the virtual meeting in real-time.

14. The method of claim 13, wherein determining that the user is requested or is about to be requested to provide information comprises one or more of:
identifying a name or a role of the user is detected in the context of the virtual meeting; or
identifying at least one of a topic, a subject, or information associated with the user as detected in the context of the virtual meeting.

15. The method of claim 12, wherein the alert notification includes one or more of a visual alert, an audio alert, a text message, or a tactile alert.

16. The method of claim 12, wherein:
monitoring the activity of the user during the virtual meeting is performed continuously; and
monitoring the context of the virtual meeting is performed in response to determining that the user is distracted.

17. A system comprising:
a detection system to detect that an attendee of a virtual meeting is distracted; and
a meeting assistant to:
monitor a context of the virtual meeting based on the attendee being distracted; and
provide a notification to the attendee that a request has been or is about to be directed to the attendee based on the context of the virtual meeting.

18. The system of claim 17, wherein the detection system is configured to detect that the attendee is distracted based on one or more of application usage, device usage, user activity, or ambient noise.

19. The system of claim 17, wherein the meeting assistant is configured to determine the context of the virtual meeting utilizing a machine-learning model with real-time automated speech recognition and natural language processing to:
transcribe the virtual meeting;
determine an updated context of the virtual meeting in real-time; and
analyze shared multimedia content in the virtual meeting.

20. The system of claim 17, wherein:
the detection system is configured to continuously monitor the activity of the user during the virtual meeting; and
the meeting assistant is configured to monitor the context of the virtual meeting in response to determining that the user is distracted.
